(19) United States
(12) Patent Application Publication
(10) Pub. No.: US 2025/0045961 A1
(43) Pub. Date: Feb. 6, 2025

(54) METHOD FOR CHECKING THE CALIBRATION OF AN IMAGE PROCESSING SYSTEM OF A SHEET METAL WORKING MACHINE

(71) Applicant: TRUMPF Werkzeugmaschinen SE + Co. KG, Ditzingen (DE)

(72) Inventors: Willi Pönitz, Leonberg (DE); Marc Teschner, Stuttgart (DE); Korbinian Weiss, Korntal (DE)

(21) Appl. No.: 18/922,493

(22) Filed: Oct. 22, 2024

Related U.S. Application Data
(63) Continuation of application No. PCT/EP2023/058284, filed on Mar. 30, 2023.

(30) Foreign Application Priority Data
Apr. 27, 2022 (DE) 10 2022 110 111.8

(51) Int. Cl. G06T 7/80; B21D 28/26; B23K 26/38

(52) U.S. Cl. CPC G06T 7/80; B21D 28/26; B23K 26/38; G06T 2207/30136

(57) ABSTRACT

A method for checking calibration of an image processing system of a sheet metal working machine includes arranging a calibration plate of a predefined shape in a removal region for processed workpieces, capturing, using at least one camera of the imaging processing system, an image of the calibration plate in the removal region, testing whether properties of the image in different test sections of the removal region correspond with stored properties of the calibration plate, and outputting a result of the testing.

### CROSS REFERENCE TO RELATED APPLICATIONS

This application is a continuation of International Application No. PCT/EP2023/058284 (WO 2023/208508 A1), filed on Mar. 30, 2023, and claims benefit to German Patent Application No. DE 10 2022 110 111.8, filed on Apr. 27, 2022. The aforementioned applications are hereby incorporated by reference herein.

### FIELD

Embodiments of the present invention relate to a method for checking the calibration of an image processing system of a sheet metal working machine, wherein a camera of the image processing system captures a removal region for processed workpieces.

### BACKGROUND

It is known from WO 2018/073418 A1 or WO 2018/073419 A1 to direct a camera at a sorting table of a flatbed machine tool for sheet metal working. After calibrating the camera to the sheet metal surface or the sorting table, an image processing algorithm can be used for part recognition. For example, an optimal sorting strategy can be suggested to an operator via a projection surface of a data source.

In order to assist operating personnel in sorting processed workpieces from a removal region, it is necessary for the image processing system to be able to correctly identify the workpieces. If the image processing system is not calibrated sufficiently accurately, this cannot be guaranteed.

WO 2016/005159 A2 describes a method for machining flat workpieces, in particular sheet metal, or three-dimensional workpieces on a processing machine. Here, a live image of a workpiece to be processed is captured using an image capture device for capturing two-dimensional images. For this purpose, the two-dimensional live image of the image capture device needs to be calibrated to the three-dimensional machine coordinate system. By calibrating at least three live image coordinates (reference image points) to known machine reference points, a working contour (e.g., a laser cut to be performed) can be displayed superimposed in the live image exactly where the contour would be worked. This means that reference points in the machine working space are clearly assigned to reference image points in the live image, thus calibrating the camera. Advantageously, one of the machine reference points can be formed by a movable machine component (e.g., by the laser processing head of a laser processing machine) which has been moved to a position known in the machine coordinate system before the at least one reference live image is captured. Alternatively, machine reference points can be added to a workpiece through machining operations, for example by marking or cutting out bolt circles. In this method, the image capture device is calibrated, in particular manually, by aligning a CAD representation with a displayed image of the workpiece.

### SUMMARY

Embodiments of the present invention provide a method for checking calibration of an image processing system of a sheet metal working machine. The method includes arranging a calibration plate of a predefined shape in a removal region for processed workpieces, capturing, using at least one camera of the imaging processing system, an image of the calibration plate in the removal region, testing whether properties of the image in different test sections of the removal region correspond with stored properties of the calibration plate, and outputting a result of the testing.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a sheet metal working machine with an image processing system which captures a removal region for processed workpieces, in a schematic perspective view, according to some embodiments;

FIG. 2 shows a schematic flow diagram of a method according to the invention for checking the image processing system, according to some embodiments;

FIG. 3 shows a schematic representation of an image of the removal region displayed on a display device of the image processing system, wherein a calibration plate is arranged in a first test section, according to some embodiments;

FIG. 4 shows the image of FIG. 3, wherein it is indicated that properties of the calibration plate were correctly detected, according to some embodiments;

FIG. 5 shows a schematic representation of an image of the removal region displayed on the display device of the image processing system, wherein the calibration plate is arranged in a second test section in which its properties were not correctly recognized, according to some embodiments; and

FIG. 6 shows a schematic representation of an image of the removal region displayed on the display device of the image processing system, wherein it is indicated that properties of a calibration plate were correctly recognized in various test sections and that the brightness perceived by the image processing system in the test sections meets a predefined criterion, according to some embodiments.

### DETAILED DESCRIPTION

Embodiments of the present invention make it possible to check the functionality of an image processing system for workpiece recognition in a simple manner.

According to embodiments of the invention, a method for checking the calibration of an image processing system of a sheet metal working machine is provided. The sheet metal working machine is, in particular, a flatbed machine. The sheet metal working machine can be a punching machine. The sheet metal working machine is preferably a laser cutting machine.

At least one camera of the image processing system captures a removal region for processed workpieces. The camera can be attached to a housing of the sheet metal working machine. The removal region can be formed on a pallet changer of the sheet metal working system. The pallet changer simplifies the removal of processed workpieces and preferably also the insertion of raw parts to be processed. The removal region is typically designed to be flat. The removal region can have an extension of more than one meter, in particular more than two meters, in the plane of its extension.

According to embodiments of the invention, the method comprises the following steps
A) arranging a calibration plate of predefined shape in the removal region,
B) capturing an image of the calibration plate,
C) testing whether properties of the image in different test sections of the removal region correspond with stored properties of the calibration plate and outputting the result of the test.

The predefined shape of the calibration plate creates a standard for comparing with the image processing system. The calibration plate can have a predefined geometry, in particular with regard to shape and/or dimensions. Alternatively or additionally, the calibration plate can have a predefined surface finish, in particular with regard to color and/or pattern.

Step A) enables the image processing system to capture an image of the calibration plate in step B). The image is then analyzed by the image processing system. In particular, properties of the test plate are extracted from the captured image. The exact nature of these properties depends on a previous calibration of the image processing system. By comparing the stored properties of the calibration plate, it can be tested in step C) whether the image processing system is correctly calibrated so that it functions reliably and can be used in particular for workpiece recognition. In particular, it can be checked whether properties extracted from the image are within a predefined tolerance range to predefined reference values for the calibration plate. By considering different test sections in step C), the calibration can be advantageously checked for the entire removal region. The test sections can, for example, be located at corners of the removal region and in its center.

The result of the test is output, for example stored in a memory of the processing device and/or transmitted to operating personnel, preferably by displaying it on a display device. If the test in step C) shows that the image processing system is correctly calibrated, the operating personnel can assume that the image processing system is working as intended. The image processing system can then be used in sheet metal working, in particular to support the operating personnel in sorting the workpieces being processed.

Multiple measuring segments of predefined shape can be formed on the calibration plate. The measuring segments can each have a predefined geometry, in particular with regard to shape and/or dimensions. Alternatively or additionally, the measuring segments can each have a predefined surface finish, in particular with regard to color and/or pattern. In step C), it can be tested for the different test sections whether properties of the image correspond with stored properties of the respective measuring segment of the calibration plate assigned to one of the test sections. By using a calibration plate with several measuring segments, a larger part of the removal region, preferably the entire removal region, can be prepared for checking the calibration by arranging the calibration plate once in the removal region.

Preferably, however, the calibration plate is arranged successively in the different test sections and steps B) and C) are repeated for the different test sections in each case. In other words, a single (smaller) calibration plate is used multiple times to test the calibration of the image processing system across the entire removal region. This simplifies the handling of the calibration plate and can in particular allow the calibration plate to be arranged manually (without mechanical assistance) in the respective test sections.

Preferably, the image processing system displays the test sections. This makes it easier to arrange the calibration plate in the different test sections.

The image processing system can comprise a display device for displaying the image captured by the camera. A transformation of the image into a plan view of the removal region is preferably displayed on the display device. This makes it easier to compare the situation in the removal region with the information displayed on the display device.

It is preferable if the image processing system displays the test sections (together with the image of the removal region or the transformation of the image) on the display device. The test sections or their boundaries can be placed over the displayed image. By looking at the display device you can see whether the calibration plate is correctly positioned.

Alternatively or additionally, the image processing system can display the test sections in the removal region. For example, lines that mark the boundaries of the test sections in which the removal region is projected can be used. This further simplifies the correct positioning of the calibration plate.

Typically, the image processing system is recalibrated if the test in step C) shows that the properties of the image do not correspond with the stored properties of the calibration plate. In this respect, embodiments of the invention also relate to a method for calibrating an image processing system of a sheet metal working machine. Inadequate calibration is thus corrected. A routine for calibrating the image processing system can be stored in a control device of the sheet metal working machine or the image processing system. The image processing system can be calibrated, for example, as described in WO 2016/005159 A2. In particular, CAD data of the calibration plate can be aligned with the captured image. This can be done manually by comparing it with a displayed image. Alternatively, this can be done automatically; displaying the image is then not necessary.

Preferably, the calibration plate is measured by the image processing system. In this method variant, the calibration plate or the measuring segments have predefined dimensions. To measure the calibration plate, edges can be extracted from the captured image and their distance in the image can be determined. Correct determination of dimensions in the entire removal region is of particular importance for the functionality of the image processing system.

In an advantageous variant of the method, a brightness value is determined for each of the different test sections in the captured image of the calibration plate. Preferably, it is tested whether a maximum deviation of the brightness values for the different test sections exceeds a predefined limit value. The limit value can be specified absolutely or, preferably, as a relative deviation (for example, a maximum of 10 percent) between the individual brightness values. The result of this test can be output, for example stored in a memory of the processing device and/or transmitted to operating personnel, preferably by display on a display device. This method variant allows the lighting situation perceptible to the image processing system to be captured and evaluated. In particular, due to the arrangement of the camera at the side of the removal region, the effective brightness for the image processing system or the camera can differ from the brightness that can be measured by means of conventional brightness measuring devices at individual points in the removal region. It is therefore not often possible to assess whether the lighting situation allows reliable use of the image processing system using separate brightness measuring devices.

It is preferable to change the lighting of the removal region if the maximum deviation of the brightness values is above the limit value. In particular, the lighting is adjusted so that the brightness values perceived by the image processing system deviate below the limit value. This makes it possible to configure a homogeneous brightness for the image processing system across the entire removal region. This increases the reliability of the image processing system.

Further features and advantages of the embodiments of the invention can be found the description. According to embodiments of the invention, the features mentioned above and those yet to be explained further may be used in each case individually or together in any desired expedient combinations. The embodiments shown and described should not be understood as an exhaustive enumeration, but rather are of an exemplary character.

FIG. 1 shows a sheet metal working machine 10, here a flatbed laser cutting machine. The sheet metal working machine 10 has a pallet changer 12 where a removal region 14 for processed workpieces 16 is formed. The workpieces 16 can in particular be removed (sorted) manually from the removal region 14 and forwarded for further processing or use.

The sheet metal working machine 10 further comprises an image processing system 18. The image processing system 18 comprises at least one camera 20 and a display device 22. In addition, the image processing system 18 or the sheet metal working machine 10 can comprise a control device, not shown in detail. The camera 20 is directed at the removal region 14, which can be seen from the dashed lines emanating from the camera 20. Here, the camera 20 captures the removal region 14 from an angle from above. An image of the removal region 14 captured by the camera 20 can be displayed on the display device 22, wherein in particular the image is transformed for display purposes into a plan view (bird's eye view) looking vertically from above onto the removal region 14.

The image processing system 18 serves to support the manual sorting of the processed workpieces 16. For this purpose, the workpieces 16 are identified in the image captured by the camera 20 and instructions for handling the individual workpieces can be displayed on the display device 22. Workpiece detection requires that the image processing system 18 is correctly calibrated.

A calibration plate is used to check the image processing system 18, in particular to test its calibration. 24. The calibration plate 24 has a predefined shape. Here, the calibration plate 24 is designed as a cuboid with known dimensions. In addition, the calibration plate 24 has a color and possibly a pattern on its surface (not shown in detail in FIG. 1).

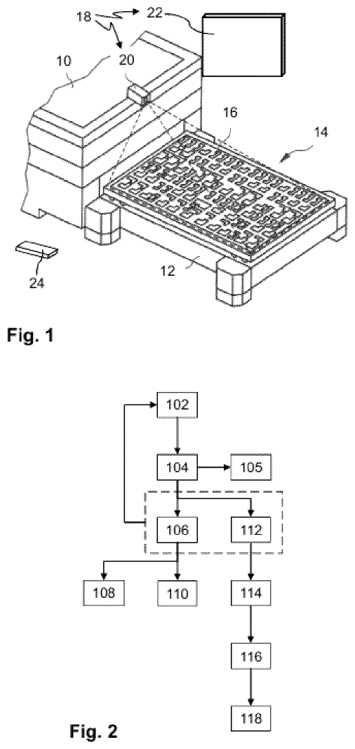

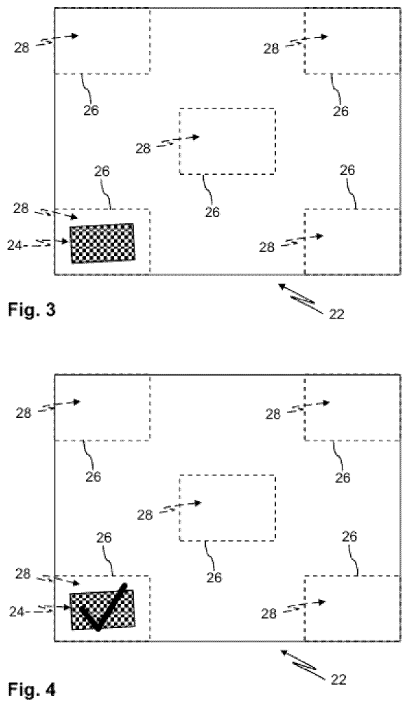

To test the calibration of the image processing system 18, the calibration plate 24 is moved in a step 102 (see FIG. 2) in a first test section of the removal region 14. The camera 20 captures an image of the removal region 14 with the calibration plate 24, see step 104. In step 105, the captured image can be displayed on the display device 22, see FIG. 3. Preferably, boundaries 26 of the test sections 28 are also superimposed in the displayed image.

In a step 106, it is tested, for example by the appropriately programmed control device, whether properties of the calibration plate 24 extracted from the captured image correspond with the stored reference values of these properties within a predetermined tolerance. For example, the calibration plate 24 can be measured via image analysis and the result of this measurement can be compared with the known dimensions of the calibration plate 24. In a step 108, the result of the test can be displayed. In particular, the result of the test can be displayed on the display device 22. In FIG. 4, a (preferably green) check mark indicates that the properties of the calibration plate 24 were correctly identified in the first test section 28.

For the calibration plate 24 arranged in a respective test section 28, in a step 112 a brightness value can be determined from the captured image.

After the image of the removal region 14 has been captured and evaluated with the calibration plate 24 arranged in the first test section 28, the calibration plate 24 is arranged in a further test section 28. The steps described above are repeated accordingly. In this way, all test sections 28 are processed one after the other.

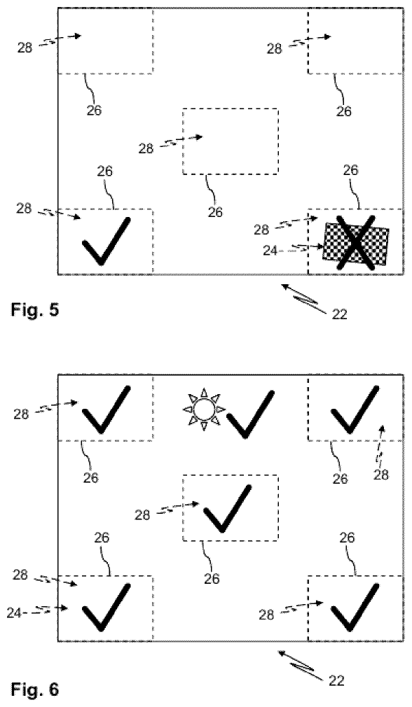

For example, the test in step 106 can reveal for a second test section 28 that the properties extracted from the captured image do not correspond sufficiently accurately to reference values for the calibration plate 24. This is output in step 108. In FIG. 5 the incorrect detection of properties of the calibration plate in the second test section 28 is indicated by a (preferably red) cross.

Since the test of the image processing system 18 in the second test section 28 has detected an inadequate function, the image processing system 18 is recalibrated in a step 110. After successful calibration, the properties of the calibration plate 24 are correctly recognized in all test sections 28. This is indicated in FIG. 6 by check marks in the various test sections 28.

The brightness values for the calibration plate 24 in the different test sections 28 can be checked for deviations from each other in a step 114. The result of this test is determined in a step 116 issued. FIG. 6 shows an example of a brightness symbol 30 displayed in the form of a sun, wherein the check mark indicates a sufficiently small deviation between the brightness values; an unacceptably large deviation could, however, be indicated by a cross. If the captured image is not sufficiently homogeneously lit in the entire removal region 14, the lighting of the removal region needs to be corrected in a step 118.

As described above, embodiments of the invention relate to a method for testing an image processing system. A calibration plate is arranged at different locations in a removal region of a sheet metal working machine. In each case, an image is captured and it is checked whether properties extracted from the image correspond with known reference values.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

Sheet metal working machine 10,
Pallet changer 12
Removal region 14
Workpieces 16
Image processing system 18
Camera 20
Display device 22
Calibration plate 24
Limits 26
Test section 28
Brightness symbol 30
Arranging 102 a calibration plate in a test section
Capturing 104 an image
Displaying 105 the image
Testing 106 whether properties of the calibration plate extracted from the image correspond with known reference values
Outputting 108 the result of the test from step 106
Calibrating 110 the image processing system
Determining 112 a brightness value
Testing 114 the brightness values for deviations from each other
Outputting 116 the result of the test from step 114
Changing 118 the lighting of the removal region

1. A method for checking calibration of an image processing system of a sheet metal working machine, the method comprising:
A) arranging a calibration plate of a predefined shape in a removal region for processed workpieces,
B) capturing, using at least one camera of the imaging processing system, an image of the calibration plate in the removal region,
C) testing whether properties of the image in different test sections of the removal region correspond with stored properties of the calibration plate, and outputting a result of the testing.

2. The method according to claim 1, wherein
multiple measuring segments of the predefined shape are formed on the calibration plate,
wherein, in step C), it is tested for each respective test section whether the properties of the image correspond with the stored properties of a respective measuring segment of the calibration plate assigned to the respective test section.

3. The method according to claim 1, wherein the calibration plate is arranged successively in the different test sections, and steps B) and C) are repeated for the different test sections in each case.

4. The method according to claim 1, wherein the image processing system is configured to display the test sections.

5. The method according to claim 1, wherein the image processing system comprises a display device for displaying the image captured by the camera.

6. The method according to claim 5, wherein a transformation of the image into a plan view of the removal region is displayed on the display device.

7. The method according to claim 5, wherein the image processing system is configured to display the test sections on the display device.

8. The method according to claim 4, wherein the image processing system is configured to display the test sections in the removal region.

9. The method according to claim 1, wherein the image processing system is recalibrated if the testing in step C) shows that the properties of the image do not correspond with the stored properties of the calibration plate.

10. The method according to claim 1, wherein the calibration plate is measured by the image processing system.

11. The method according to claim 1, wherein a brightness value is determined for each of the different test sections in the captured image of the calibration plate.

12. The method according to claim 11, wherein, in step C), it is tested whether a maximum deviation of the brightness values for the different test sections exceeds a predefined limit value.

13. The method according to claim 12, wherein lighting of the removal region is changed if the maximum deviation of the brightness values is above the limit value.

14. The method according to claim 1, wherein the removal region is formed on a pallet changer of the sheet metal working machine.
